(19) United States
(12) Patent Application Publication
(10) Pub. No.: US 2004/0240196 A1
(43) Pub. Date: Dec. 2, 2004

(54) Domestic appliance

(75) Inventors: Gerd Wilsdorf, Olching (DE); Hans Lappat, Garching/Alz (DE); Michael Ulmer, Traunreut (DE); Helmut Uglorz, Steinheim (DE)

Correspondence Address: John T. Winburn, BSH Home Appliances Corporation, 100 Bosch Blvd, New Bern, NC, 28562, US

(73) Assignee: BSH Bosch und Siemens Hausgerate GmbH, Munich (DE)

(21) Appl. No.: 10/771,660

(22) Filed: Feb. 4, 2004

(30) Foreign Application Priority Data
Aug. 8, 2001 (DE) 10138885.3
Aug. 6, 2002 (WO) PCT/EP02/08785
Aug. 6, 2002 (WO) 03/014638 A1

(51) Int. Cl. F21V 33/00

(52) U.S. Cl. 362/89

(57) ABSTRACT

A domestic appliance containing a utility space, a door for closing off the space, a door handle, and an electrical control circuit. The utility space including an illumination device for illuminating the utility space when the door handle capacitance is changed by coming in contact with human touch.

The invention relates to a domestic appliance according to the preamble to claim 1.

According to this, the invention relates to a domestic appliance comprising an appliance body in which a utility space is formed, a illumination device for lighting the utility space, a door for closing off the utility space, a door handle, and an electric control circuit for automatically switching on the illumination device as a function of human touch on the door handle.

Domestic appliances of this type are, in particular, cookers, ovens, microwave appliances, refrigerators, deep-freezes, and other domestic appliances which have a utility area (oven muffle, refrigerated area for foodstuffs, freezer compartment, and the like).

From U.S. Pat. No. 5,909,950 a refrigerator or deep-freeze of this type is known, with a door handle which carries a contact sensor, which takes effect on being touched by a user such as to cause an internal lamp in the refrigerator or deep-freeze to be switched on automatically. As a result, the lamp is already switched on when the door is opened, and the user can see the contents of the refrigerator immediately. In addition, a switch is provided which can be actuated by the door in order to recognise whether the door is open or closed. A control circuit and a computer switch the lamp on when the door handle is touched. If the position of the switch of the control circuit signals that the door is open, the lamp will be retained in the switched on state. If by contrast the switch signals that the door is closed, the lamp of the control circuit will automatically be switched off again.

The invention is intended to resolve the problem of providing a simple and operationally reliable circuit for the illumination device.

This problem is resolved according to the invention by the characterisation features of claim 1.

The domestic appliance is characterised according to the invention in that the door handle is designed as a capacitor body, the capacitance of which may be altered by human touch, that the door handle consists of electrically conductive material or contains such material as a part of the capacitor body, that an electrically conductive path is formed from the electrically conductive material of the door handle to the control circuit, and that the control circuit is designed to identify the capacitance and for automatic actuation of the illumination device as a function of the capacitance of the door handle. As an alternative, instead of the door handle, provision can also be made in general for a contact element, such as a section of a facia or panel of the domestic appliance.

In this way an operationally reliable and long-lived circuit is created in a simple manner for the illumination device.

Further features of the invention are contained in the sub-claims and in the following Description.

The invention realises a capacitative recognition of a contact with the door handle. The control circuit used for this purpose can be designed in a similar manner to that of the known zone switches of cooking surfaces of ovens. The invention can be designated as “Touchlight”, and is based on the recognition of a change in capacitance at the door handle of the door of the domestic appliance. The one or more oven lamp or lamps are switched on automatically as a function of such alterations in capacitance.

The principle of Touchlight may correspond to that of an electronic zone switch of electrical cooking surfaces of ovens. Instead of a touch via the glass ceramics of the cooking surfaces, however, in the present case a sensor input of the electrical control circuit is connected in an electrically conductive manner to the door handle of the appliance door, such as the oven door. The capacitative sensor of the control circuit is connected via an electrically conductive path to the door handle of the door. The conductive path contains for preference a switch contact. The door handle can consist of stainless steel, aluminium, or conductive plastic, whereby the surface can be coated or anodised. The capacitance of the door handle measured by the sensor of the control circuit changes depending on the state of the door, i.e. depending on whether a person is touching the door handle or not.

Accordingly, the state of the door handle being touched and the door opened can be distinguished from the state of the door being closed by means of different voltage levels at the capacitative sensor of the control circuit.

The electrical control circuit of the illumination device can be linked to an appliance operation circuit and/or its operating software, so that the operation of the control circuit of the illumination device is additionally dependent on the particular switching state or operational state of the appliance operation circuit, for example as a function of the particular setting of a function selector of an oven. Thanks to the possibility of a direct touch on an electric circuit at the door handle, the entire circuit arrangement must be operated with safety voltage. In this situation, safety intervals must also be maintained between the parts for the safety voltage and the parts for mains voltage. The separation of the touchable components from the components which cannot be touched because of high voltage can be effected by means of opto-electronic couplers. Circuits of this kind are known with the zone switches of cooking surfaces.

The invention is described hereinafter with reference to drawings on the basis of preferred embodiments as examples. The drawings show:

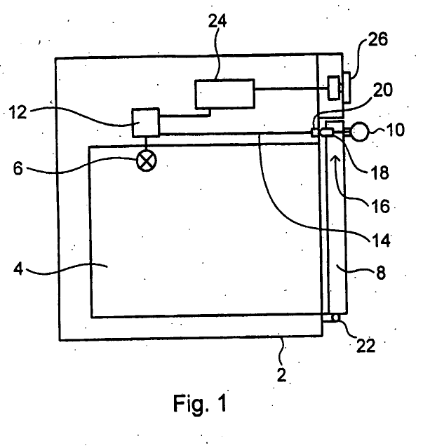

FIG. 1: In diagrammatic form, a vertical cross-section through a domestic appliance according to the invention;

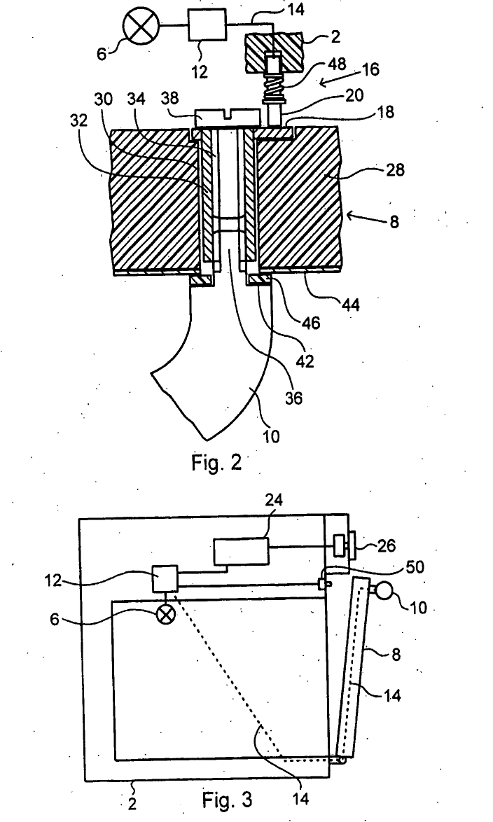

FIG. 2: An enlarged detail from FIG. 1;

FIG. 3: In diagrammatic form, a vertical cross-section through a domestic appliance according to the further embodiment according to the invention.

The domestic appliance from FIG. 1, such as a cooker, an oven, or a microwave device, contains a device body 2, in which a utility space 4 is formed, such as, for example, a cooking area, grill space, roasting space, or the like, an illumination device 6, of which only a lamp is shown, but in which several lamps can be located, which can be arranged in the utility space 4 or arranged on the outside separated from it by a glass wall, for the illumination of the utility space 4, and a door 8 for closing off the utility space 4. The door 8 is provided with a door handle 10. An electronic control circuit 12, which for preference contains a computer or a microcontroller, or is connected to such, is connected to the illumination device 6, in order to switch this on automatically as a function of a human touch on the door handle 10. The control circuit 12 is for preference arranged in or at the appliance body 2. According to an embodiment not shown, it can also be arranged in the door 6.

The door handle is designed as a capacitor body, the capacitance of which may be altered by human touch. The door handle 10 consists of electrically conductive material or contains electrically conductive material as a part of the capacitor body, which is electrically connected by an electrically conductive path 14 to the control circuit 12. The control circuit 12 is designed to recognise the capacitance of the door handle 10 and for the automatic actuation of the illumination device 6 as a function of the capacitance of the door handle 10, which is detected by the control circuit by means of the capacitance sensors contained in it. This detection of the capacitance can be effected by measuring the capacitance value or by a sensor circuit, which in each case only responds to predetermined changes in the capacitance values.

The electrical path 14 contains an interruption contact arrangement 16, which closes the path 14 (establishes the electrical connection) when the door 8 is closed, and interrupts it when the door is opened. The interruption contact arrangement 16 contains a contact part 18 at the door 8 and a contact part 20 which can therefore be contacted by the closing of the door, said contact part being arranged at the appliance body 2 and electrically isolated from it. The two contact parts 18 and 20 are opened by the opening of the door, when in this situation the door end, provided with a contact part 18 and remote from the pivot axis 22 of the door 8, is moved a little away from the appliance body 2. Conversely, the contact parts 18 and 20 are automatically brought into electrical contact connection with each other when the door 8 is closed, already shortly before the door 8 is completely closed, i.e. a few tenths of a millimetre or a few millimetres before the fully closed position of the door.

The electrical control circuit 12 is also designed to actuate the illumination device 6 as a function of whether the interruption contact arrangement 16 and therefore also the door 8 is closed or open.

If the door 8 is open, the control circuit 12 can no longer identify whether a human touch is being effected on the door handle 10 or not.

The control circuit 12 switches the illuminating device 6 on when the door handle 10 is touched manually by a user with the door 6 closed. For preference, the control circuit 12 automatically switches the illuminating device 6 off again if the door 8 is not opened after this switching on process. In addition, the control circuit 12 is for preference designed in such a way that it automatically switches the illumination device 6 off again after the door 8 is closed.

The invention provides an operationally reliable control of the illumination device 6 by way of a simple design. Thanks to the arrangement of the control circuit 12 in or at the appliance body 2 instead of in the door 8, the door also has a lighter weight.

The control circuit 12 can be connected to an appliance operating circuit 24 or in part formed by such a circuit, and designed to switch the illumination device 6 as a function of the individual switching state of the appliance operating circuit 24, in such a way, for example, that the illumination device 6 can only be switched on if the domestic appliance is also switched on by an operating element 26, and therefore the appliance operating circuit 24 is also switched on.

According to a preferred embodiment of the invention, the control circuit 12 is designed as a dimmer circuit, by means of which, when switched on, the illumination device 6 automatically passes from the switched off state into the fully switched on lighting state through a lighting state which slowly becomes stronger (dimmer state).

According to the same or another embodiment of the invention, the control circuit 12 is designed as a dimmer circuit by means of which the illumination device 6, at switching off, automatically passes from the fully switched on state to the fully switched off state slowly through a dimmer state.

Such a dimmer circuit is of particular advantage when the illumination device 6 is switched off, because then the user can for a while still observe the utility space 4 and, in particular, its contents during the dimmed switching off process. When turned on, a dimming process has the advantage that a user will not be suddenly dazzled by the light.

According to a preferred embodiment of the invention, a part of the electrical path 14, which is located in the door 8, is designed as a securing element for securing the door handle 10 to the door 8.

FIG. 2 shows a preferred embodiment for this. A door part 28 at the upper end of the door 8 consists, for example, of electrically insulating material, such as plastic, and contains a passage hole 30. A tube 32 of electrically conductive material, such as brass, extends through the hole 30 and has an internal thread 34. The tube 32 is screwed onto a threaded element 36 of the handle 10, consisting of electrically conductive material. Screwed into the end of the tube 32, turned away from the handle 10, is a screw 38, which is in electrical contact with the tube 32 and, in addition, is in contact with a plate-shaped contact part 18 of the interruption contact arrangement 16. By means of its screw head, the screw 38 tensions the contact part 18 against the door part 28 on the inside of the door, whereby an element 42 of the handle 10 is supported on the outside of the door. If the door part 28 consists of electrically conductive material, or is provided with an electrically conductive cover layer 44, then an isolating disk 46 of electrically insulating material must be inserted between the element 42 of the handle 10 and the electrically conductive part 44 of the door part 28.

The other contact part 20 provided on the appliance body 2 (and/or the one contact part 18) is mounted in a spring elastic manner by means of a pressure spring 48 in the door closure direction. This accordingly also guarantees a secure contact of the two contact parts 18 and 20, as well as a tight closure of the door 8 on the front side of the utility space 4, if the parts are manufactured with large tolerances or if material deformations occur due to temperature changes.

If the handle 10 consists of electrically conductive material, then its capacitance changes when it is touched by a person, because in this situation a capacitance is added by the person. If the handle 10 has a surface made of electrically insulating material, and an electrically conductive core located inside that, then the capacitance of the handle 10 will change in a similar manner when touched by a person to the way in which the capacitance can be changed with a plate capacitor by changing the medium between the capacitor plates.

In a further embodiment of FIG. 3, the corresponding parts from FIGS. 1 and 2 are provided with reference figures. The only difference lies in the fact that the electrically conductive path 14 is formed free of interruption from the handle 10 as far as the control device 12. In order for the control circuit 12 to be able to identify whether the door 8 is open or closed, a pressure switch or button 50 is provided at the appliance body 2, which is actuated by the closing or opening door 8. The switching state of the button or pressure switch 50 in each case is identified by a control circuit 12 connected to it.

1-10 (canceled)

11. A domestic appliance, comprising:
an appliance body including a utility space formed therein;
an illumination device for illuminating said utility space;
a door for closing off said utility space;
a contact element;
an electric control circuit for automatically switching on said illumination device as a function of human touch on said contact element;
said contact element formed as a capacitor body whose capacitance is altered by human touch;
said contact element having at least a portion formed of an electrically conductive material;
an electrically conductive path formed from said electrically conductive material of said contact element to said control circuit;
said control circuit sensing said capacitance of said contact element capacitor; and
said control circuit automatically switching on said illumination device as a function of said sensed capacitance of said contact element.

12. The domestic appliance according to claim 11, including a door handle formed on said door, said door handle forming said contact element.

13. The domestic appliance according to claim 11, including a switch actuated by said door and electrically connected to said control circuit, said switch having different switch states depending upon whether said door is open or closed and said control circuit controls said illumination device as a function of said switch state and therefore as a function of whether said door is open or closed.

14. The domestic appliance according to claim 11, including said control circuit is arranged at or in said appliance body and said electrically conductive path includes an interruption contact arrangement which closes said path when said door is closed and opens said path when said door is open, said interruption contact arrangement includes a contact part contacting said door and a contact arranged at said appliance body and said control circuit operates as a function of said interruption contact arrangement and therefore as a function of whether said door is open or closed.

15. The domestic appliance according to claim 11, including said control circuit including a dimmer circuit for switching on said illumination device automatically through an illumination state which slowly becomes more illuminated from a dimmed state to a fully switched on illumination state.

16. The domestic appliance according to claim 11, including said control circuit including a dimmer circuit for switching off said illumination device automatically from a fully switched on illumination state through a progressively dimmer illumination state to a fully switched off illumination state.

17. The domestic appliance according to claim 12, including a portion of said electrically conductive path including a securing element for securing said door handle to said door.

18. The domestic appliance according to claim 12, including said door handle having at least a portion of said electrically conductive material formed on a surface thereof where it can be contacted by said human touch upon actuation of said door.

19. The domestic appliance according to claim 18, including said portion of said electrically conductive material is covered by an electrically insulating material where it can be contacted by said human touch upon actuation of said door.

20. The domestic appliance according to claim 11, including an appliance operation circuit coupled to said control circuit and said control circuit automatically switching on said illumination device as a function of the switching state of said appliance operation circuit.
